(19) United States
(12) Patent Application Publication
(10) Pub. No.: US 2011/0229794 A1
(43) Pub. Date: Sep. 22, 2011

(54) Composite Cathode for Use in Solid Oxide Fuel Cell Devices

(75) Inventors: Monika Backhaus-Ricoult, Horseheads, NY (US); Michael Edward Badding, Campbell, NY (US); Jacquelin Leslie Brown, Lindley, NY (US); Kimberley Louise Work, Painted Post, NY (US)

(73) Assignee: Corning Incorporated

(21) Appl. No.: 12/671,746

(22) PCT Filed: Aug. 6, 2008
(86) PCT No.: PCT/US08/09425

§ 371 Date: Feb. 2, 2010

Related U.S. Application Data
(60) Provisional application No. 60/963,932, filed on Aug. 8, 2007.

(51) Int. Cl. H01M 8/10; H01M 4/86; H01M 4/88; B05D 5/12; B05D 3/02

(52) U.S. Cl. 429/482; 429/532; 427/115

(57) ABSTRACT

Disclosed are composite electrodes for use in a solid oxide fuel cell devices. The electrodes are comprised of a sintered mixture of lanthanum strontium ferrite phase and yttria stabilized zirconia phase. The lanthanum strontium ferrite phase has the general formula (LaₓSr_{y})i±δ(FeₐMn_{b}Co_{c})O₃; wherein 1.O≧x≧0.65; 0.35≧y≧0.0; x+y=1.0, δ=0-0.1, a+b+c=1, and a>0.6. Also disclosed are methods of making the composite electrodes and solid oxide fuel cell devices comprising same.

### BACKGROUND OF THE INVENTION

1. Field of the Invention

The present invention relates to solid oxide fuel cells and, more specifically, to composite oxygen conducting cathodes for use in solid oxide fuel cell devices.

2. Technical Background

In recent years, solid oxide fuel cells (SOFC) have attracted interest for power generation, producing electricity from fuels including hydrogen, hydrocarbons and fossil fuels, and converting pollution-free the chemical energy of the fuel into electrical energy. A typical SOFC comprises a dense oxygen ion-conducting ceramic electrolyte layer sandwiched between porous air electrode (cathode) and porous fuel electrode (anode). In operation, electrical energy is produced by electrochemical combination of the fuel with the oxidant.

Yttria-stabilized zirconium oxide (YSZ) is currently the most commonly employed electrolyte material due to its mechanical, electrical, chemical and thermal properties. Cubic YSZ offers higher ionic conductivity and lower strain tolerance while 3YSZ offers higher strength at comparably lower (around a third) oxygen ion conductivity. At present, the anodes in most commercial and prototype solid oxide fuel cell devices are made of nickel-YSZ cermet, and the cathodes are typically made of lanthanum manganites, lanthanum ferrites or lanthanum cobaltites. In such fuel cells, the oxygen reacts with the electrons on the surface of the cathode to form oxygen ions that migrate through the electrolyte to the anode, where they react with fuel, such as hydrogen, to produce electrons and water. The electrons flow from the anode through an external circuit to the cathode, while providing usable power. The theoretical open circuit voltage of single cell devices composed of YSZ electrolyte with anode and cathode is usually not reached in experiments, due to ohmic resistance, restricted ion mobility and electrode polarization.

Oxygen incorporation at the cathode occurs through a number of different reaction steps such as diffusion through the cathode pore network, adsorption, dissociation, charge transfer and exchange with oxygen vacancies. All can contribute to the cathode resistance. For the different types of cathode materials typically used, the rate limiting steps for the oxygen incorporation can differ. For example, lanthanum strontium manganite (LSM) has low ionic conductivity; as a result, oxygen incorporation mainly occurs at the triple phase boundaries, the contact points between ion-conducting electrolyte, electron-conducting LSM and gas phase. Due to the limited number of triple phase boundary sites (even in a LSM/YSZ composite cathode), charge transfer at the triple phase boundary is usually rate-controlling at high temperature. Due to the limitation of the oxygen incorporation in LSM-based cathodes to the triple phase boundary, those cathodes are very vulnerable to all types of pollution, poisoning and reactions occurring at the triple phase boundary. Thus LSM-based cathodes typically suffer severe performance degradation under harsh processing or operating conditions. For example, during processing insulating phases such as pyrochlore can form by reaction between YSZ and LSM. Further, during firing or operation, impurities such as Si can segregate to the triple phase boundary and form blocking layers. Still further, when triple phases boundaries are flooded by borosilicates from glass seals or when chromites deposit by electrochemically induced decomposition of volatile CrO₂(OH)₂ or CrO₃ gases, the oxygen incorporation rates during processing can be diminished to nearly a complete inhibition.

Accordingly, there is a need in the art for improved electrode materials that can exhibit improved performance and processing properties when used, for example, as cathodes in solid oxide fuel cell devices.

### SUMMARY OF THE INVENTION

Embodiments of the present invention can provide composite electrode materials suitable for use as cathodes in solid oxide fuel cell devices. In one embodiment, the composite electrodes comprise a sintered mixture of lanthanum strontium ferrite component having the formula (LaₓSr_{y})_{1±δ}(FeₐMn_{b}Co_{c})O₃ and a stabilized zirconia; wherein 1.0≧x≧0.65; 0.35≧y≧0.0; x+y=1.0, δ=0-0.1, a+b+c=1 and a>0.6. Among several advantages, the composite electrodes can exhibit high chemical stability at temperatures up to at least 1250° C., reach high electrochemical performance, remain stable under polarization and preserve rather high performance during long-time cathode operation in the presence of conventional or currently known seal glasses or when also exposed to chromium sources. In use, the electrode materials of the present invention can therefore enable solid oxide fuel cell devices to operate at higher performance levels, such as for example increased power density.

In another embodiment, a method of making a porous composite electrode is provided. The method generally comprises depositing an unsintered mixture of a lanthanum strontium ferrite component having the formula (LaₓSr_{y})_{1±δ}(FeₐMn_{b}Co_{c})O₃ and a stabilized zirconia; wherein 1.0≧x≧0.65; 0.35≧y≧0.0; x+y=1.0, δ=0-0.1, a+b+c=1 and a>0.6. Once deposited, the deposited mixture can then be sintered or fired under conditions effective to convert the unsintered mixture of the lanthanum strontium ferrite component and yttria stabilized zirconia into a porous composite suitable for use as a cathode catalyst in the solid oxide fuel cell cathode. The cathode can be formed entirely of the described catalyst layer or, alternatively, can comprise the described catalyst layer and an additional current collector top layer. As will be appreciated by one of ordinary skill in the art, a variety of suitable current collectors are conventionally known and can, for example, be comprised of a variety of materials including porous zirconia-metal composites.

Additional embodiments of the invention will be set forth, in part, in the detailed description, and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

The accompanying drawings, which are incorporated in and constitute a part of this specification, illustrate certain embodiments of the instant invention and together with the description, serve to explain, without limitation, the principles of the invention.

FIG. 1 is an SEM image of an exemplary LSF/3YSZ composite cathode according to one embodiment of the present invention.

FIG. 2 is an SEM view after etching the perovskite of the interfacial plane of reaction couples between an exemplary 3YSZ electrolyte, 8YSZ electrolyte and 10YSZ single crystal and a screen-printed (Sr_{0.2}La_{0.8})FeO₃ layer. The reaction couples were annealed in air at 1000° C. for 100 hours (upper part) and at 1250° C. for 25 h (lower part).

FIG. 3 is a TEM image showing the initial stages of pyrochlore formation at the interface in a (Sr_{0.2}La_{0.8})FeO₃/3YSZ reaction couple after annealing at 1250° C. for 25 h, the figure also shows the diffraction patterns of the newly formed pyrochlore and preceding cubic zirconia phase.

FIG. 4 illustrates cathode impedance data in air at 750° C. for oxygen pump samples of a first exemplary (Sr_{0.2}La_{0.8})FeO₃/3YSZ cathode catalyst material and the related (Sr_{0.2}La_{0.8})_{0.97}MnO₃/3YSZ catalyst, with 3YSZ electrolyte (about 20 micrometers in thickness) and Ag/YSZ-based current collector on both sides during operation. The first type of exemplary cathode is a high porosity cathode as shown in FIG. 1.

FIG. 5 illustrates exemplary current density and voltage characteristics (i-V) as a function of temperature for cathode/cathode single cells with high porosity (Sr_{0.2}La_{0.8})FeO₃/3YSZ composite cathode, 3YSZ electrolyte and Ag/3YSZ-based current collector sampled in ambient air.

FIG. 6 illustrates the temperature dependency in air and at low oxygen partial pressure of rate determining oxygen incorporation step in an exemplary high porosity (Sr_{0.2}La_{0.8})FeO₃/3YSZ cathode.

FIG. 7 presents impedance spectra of cathode pump samples with 3YSZ electrolyte (about 20 micrometers in thickness) and Ag/YSZ-based current collector on both sides in air for exemplary (Sr_{0.2}La_{0.8})FeO₃/3YSZ and (Sr_{0.2}La_{0.8})FeO₃/8YSZ after t=10 hours and t=1300 hours at 725° C. The exemplary LSF/YSZ composite of FIG. 7 has less porosity than the exemplary composites of FIGS. 4, 5, and 6.

FIG. 8 illustrates a comparison of the current density—voltage characteristics for cathode pump samples with exemplary (Sr_{0.2}La_{0.8})FeO₃/3YSZ and (Sr_{0.2}La_{0.8})FeO₃/8YSZ composites together with 3YSZ electrolyte (about 20 micrometers in thickness) and Ag/YSZ-based current collector on both sides after operation in air at 725° C. for 10 hours and 1300 hours. The exemplary LSF/YSZ composite of FIG. 7 has less porosity than the exemplary composite of FIGS. 4, 5, and 6.

FIG. 9 (FIGS. 9a and 9b) illustrates the evolution of performance with time of the LSF/3YSZ pump sample described in FIGS. 4, 5, and 6 to that of the corresponding LSM/3YSZ pump sample during exposure to an alkali-containing borosilicate seal at 750° C. in air. FIG. 9a shows cathode impedance spectra after different operation time. FIG. 9b shows current density-voltage characteristics after different cell operation time.

FIG. 10 illustrates the evolution of current density over time at 0.5V, 750° C. in air for the cathode pump sample described in FIGS. 4, 5, and 6 and the corresponding LSM/3YSZ cell in the presence of a borosilicate glass.

FIG. 11 illustrates evolution with time of the relative current density at 0.5V for the exemplary LSF/3YSZ cathode of FIGS. 4, 5, and 6 when operated under bias −0.3V at 750° C., humid air flow and exposed to vapor from a chromium oxide powder bed.

### DETAILED DESCRIPTION

The following description of the invention is provided as an enabling teaching of the invention in its best, currently known embodiment. To this end, those skilled in the relevant art will recognize and appreciate that many changes can be made to the various embodiments of the invention described herein, while still obtaining the beneficial results of embodiments of the present invention. It will also be apparent that some of the desired benefits of embodiments of the present invention can be obtained by selecting some of the features described herein without utilizing other features. Accordingly, those who work in the art will recognize that many modifications and adaptations are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise. Thus, for example, reference to an “electrode” includes embodiments having two or more such electrodes unless the context clearly indicates otherwise.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

As used herein, a “wt. %” or “weight percent” or “percent by weight” of a component, unless specifically stated to the contrary, is based on the total weight of the composition or article in which the component is included.

As briefly summarized above, embodiments of the present invention can provide oxygen conducting composite electrodes suitable for use in solid oxide fuel cell devices. The composite electrodes comprise a sintered mixture of lanthanum strontium ferrite and stabilized zirconia. Among several advantages exemplified in the examples which follow, the composite electrodes can exhibit relatively high chemical stabilities at temperatures up to at least 1250° C., can reach relatively high electrochemical performance, are relatively stable under polarization and preserve relatively high performance, such as power density, even during prolonged periods of operation and in presence of borosilicate and other glasses as well as chromium sources. Still further, the composite electrodes have a relatively broader processing window and, to that end, can be fired at temperatures up to at least 1250° C. for several hours without any substantial pyrochlore formation.

The composite electrodes are formed of a sintered mixture of lanthanum strontium ferrite and stabilized zirconia. The stabilized zirconia component of the mixture can comprise any desired amount of calcia, magnesia, yttria and other rare earth oxides, including for example a 3 mol % yttria stabilized zirconia, an 8 mol % yttria stabilized zirconia, or even a 10 mol % yttria stabilized zirconia. However, in one embodiment, a preferred yttria stabilized zirconia is the 3 mol % yttria stabilized zirconia also referred to herein as yttria (3 mol %) stabilized zirconia or 3YSZ.

The lanthanum strontium ferrite component, also referred to herein as LSF, can contain various small amount partial substitutions on the A-site others than Sr and La and can also contain partial substitutions on the perovskite B-site, such as for example Mn, Co and others. Accordingly, in one embodiment the LSF compound can be characterized by the formula (LaₓSr_{y})_{1±δ}(FeₐMn_{b}Co_{c})O₃; wherein 1.0≧x≧0.65; 0.35≧y≧0.0; x+y=1.0, δ=0-0.1, a+b+c=1 and a>0.6. In a preferred embodiment, the lanthanum strontium ferrite component can be characterized by the formula (LaₓSr_{y})_{1-δ}FeO₃ and in an even further preferred embodiment as (La_{0.8}Sr_{0.2})FeO₃.

The components of the sintered mixture can be present in any desired weight ratio, however, in one embodiment it is preferred for the composite electrode to comprise from about 30 weight % to about 90 weight % of the lanthanum strontium ferrite and from about 70 weight % to about 10 weight % of yttria stabilized zirconia. In still a more preferred embodiment, the sintered composite electrode comprises about 40 weight % lanthanum strontium ferrite and about 60 weight % of the yttria stabilized zirconia.

To prepare the composite electrodes, an unsintered mixture of the lanthanum strontium ferrite component and the stabilized zirconia component can be deposited onto a substrate. In one embodiment, the composite electrode can be formed on and in direct contact with (i.e., in the absence of intervening layers) an electrolyte membrane or sheet, such as those commonly used in solid oxide fuel cell devices. For example, in one embodiment the substrate can be an electrolyte sheet comprised of a yttria stabilized zirconia. Further, the electrolyte sheet can have any desired thickness, including for example, a thickness that is less than or equal to 50 μm. In still another embodiment, it is desired that the electrolyte sheet be less than or equal to 40 μm, less than or equal to 30 μm, or even less than or equal to 20 μm. Once deposited, the mixture can then be sintered under conditions effective to form a sintered solid oxide fuel cell electrode on the substrate.

The unsintered mixture of lanthanum strontium ferrite and stabilized zirconia can be obtained by blending the desired relative amounts of the lanthanum strontium ferrite component and the stabilized zirconia component. As described above, these components can be blended together in any desired ratio, including for example about 30 weight % to about 90 weight % of the lanthanum strontium ferrite and from about 70 weight % to about 10 weight % of stabilized zirconia. The unsintered mixture can, for example, be deposited onto a substrate such as an electrolyte membrane, by a screen printing process. To that end, a printable ink composition can be obtained comprising the blended unsintered powder batch mixture dispersed in a liquid vehicle system which can further comprise one or more dispersants, binders, or organic solvents. The dispersed powders and the vehicle system can also be blended together in any desired ratio to reach the desired porosity in the resulting composite cathode material. For example, in one embodiment an exemplary ink composition can be obtained by providing an unsintered mixture of 40 volume % (La_{0.8}Sr_{0.2}) FeO₃ and 60 volume % 3YSZ. The exemplary unsintered mixture can then be mixed with an organic liquid vehicle at a 10.5 vol % solids loading concentration. In another exemplary embodiment, a mixture of 40 volume % (La_{0.8}Sr_{0.2}) FeO₃ and 60 volume % 3YSZ can be mixed and loaded at 15 vol % solids loading concentration into an organic vehicle. In still another embodiment, a mixture of 40 volume % (La_{0.8}Sr_{0.2}) FeO₃ and 60 volume % 8YSZ can be mixed and loaded at 15 vol % solids loading concentration into an organic vehicle.

Once blended, an ink composition comprising the dispersed unsintered mixture can be deposited onto a substrate, such as for example, a ceramic electrolyte membrane suitable for use in a solid oxide fuel cell device. As mentioned above, in one embodiment the ink can be deposited using a screen printing process. If desired, the printing process can also be automated.

The deposited unsintered LSF/YSZ mixture can then be fired under conditions effective to convert the unsintered mixture into a sintered porous composite electrode comprising the selected lanthanum strontium ferrite component and the selected yttria stabilized zirconia component. It should be understood that the particular firing or sintering conditions to be used will depend, at least in part, on the particular composition of the unsintered mixture and the amount deposited onto the substrate. However, in one embodiment, suitable firing conditions can comprise heating the deposited mixture at a sintering temperature in the range of from 1000° C. to 1250° C. for approximately 2 hours.

In use, the composite electrodes are well suited for use as cathodes in solid oxide fuel cell devices and can exhibit several improved processing and performance characteristics. In one embodiment, the composite electrode materials of the can exhibit improved, i.e., reduced, levels of cathode area specific resistance when utilized as a cathode in a solid oxide fuel cell device. To that end, as referred to herein a cathode area specific resistance was determined by first measuring the total cathode area resistance for a cathode oxygen pump sample comprising two symmetrically identical cathodes positioned on either side of an electrolyte sheet and operated at 0.5V in air at 750° C. This total cathode pump resistance was then divided by two to determine the cathode area specific resistance for each of the two cathodes utilized in the oxygen pump sample.

For example, a cathode pump sample with two symmetric identical composite electrodes can exhibit a cathode resistance less than approximately 0.15 ohms cm² when measured at 0.5V and at 750° C. (according to conventions established by those skilled in the art, the resistance of one individual cathode is considered as half of that value, 0.07 ohm cm²). Similarly, the inventive composite electrodes also exhibit an improved, i.e., increased, current density. For example, oxygen pump samples with a thin electrolyte and two of these composite electrodes can exhibit a current density of at least 1.0 A/cm² when measured at 0.5 volts and 750° C. Still further, oxygen pump samples with a 20 micrometer thick thin electrolyte and two of these electrodes can even exhibit a current density of at least 1.3 A/cm², or even at least 1.5 A/cm² when measured at 0.5 volts and 750° C. Still further, the inventive composite electrodes show lower degradation of their performance during operation in cathode pump cells and in stacks. Lower degradation in a stack environment was simulated by cathode operation under polarization, in the presence of seal glass and when exposed to CrO₃ vapor.

### EXAMPLES

To further illustrate the principles of embodiments of the present invention, the following examples of inventive oxygen conducting composite electrode compositions are put forth so as to provide those of ordinary skill in the art with a complete disclosure and description of how the composite electrodes and methods claimed herein can be made and evaluated. They are intended to be purely exemplary of the invention and are not intended to limit the scope of what the inventors regard as their invention. Efforts have been made to ensure accuracy with respect to numbers (e.g., amounts, temperatures, etc.); however, some errors and deviations may have occurred. Unless indicated otherwise, parts are parts by weight, temperature is ° C. or is at ambient temperature, and pressure is at or near atmospheric.

In the following examples, the LSF/3YSZ composite cathodes evaluated had the stoichiometric formula (La_{0.8}Sr_{0.2})FeO₃ and 3YSZ. These cathodes were prepared by providing an unsintered mixture comprising 40 weight % of the LSF component and 60 weight % of the 3YSZ component. To provide a printable ink composition, the powders were mixed with a liquid vehicle system containing dispersants, binders, and an organic solvent. For higher porosity composite layers (type A), the 40 volume % (La_{0.8}Sr_{0.2}) FeO₃ and 60 volume % 3YSZ powder mixture was loaded at 10.5 vol % concentration into the vehicle system. For lower porosity composites (type B), 40 volume % (La_{0.8}Sr_{0.2}) FeO₃ and 60 volume % 3YSZ powder mixtures were loaded at 15 vol % concentrations into the vehicle system. For obtaining comparative LSF/8YSZ composites, 40 volume % (La_{0.8}Sr_{0.2}) FeO₃ and 60 volume % 8YSZ were mixed and loaded at 15 vol % concentrations into the vehicle system. For obtaining comparative LSM/3YSZ composites, 40 volume % (La_{0.8}Sr_{0.2})_{0.98} MnO₃ and 60 volume % 3YSZ were mixed and loaded into the organic vehicle.

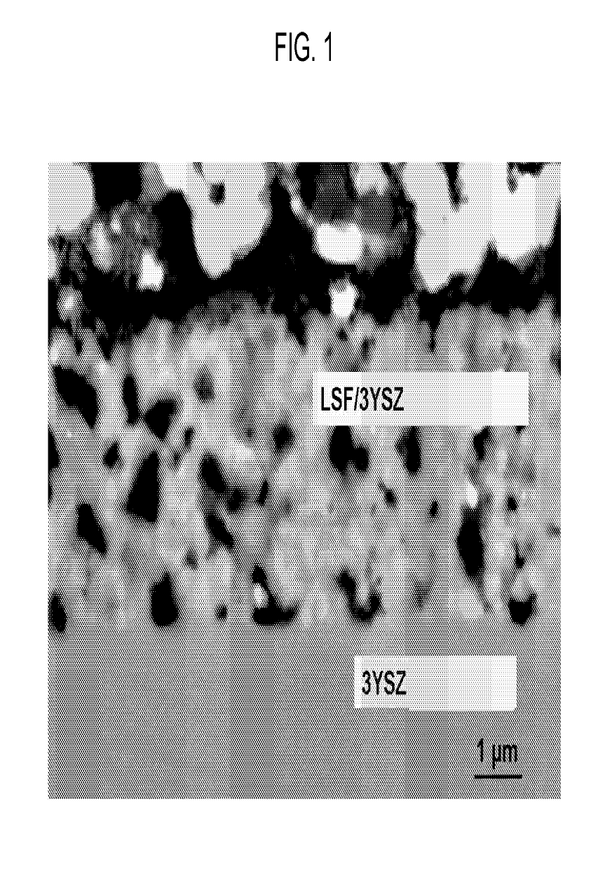

Once blended, the ink compositions were printed onto the YSZ electrolyte using a semi-automatic screen printer (de Haart). The substrate had a thickness of about 20 microns. The deposited layer of ink was approximately 4 microns thick. The 3YSZ ceramic substrate was mounted on the printer. A print of the planned design was placed on the cloth covered mounting platen. Aligning to the dried print on the mounting platen provided the desired registration of the print. Each substrate was then printed and dried for about 2 minutes at about 145° C., before printing the opposite side. It should be noted that the temperature of the drying oven also varied by about 10° C. as more substrates were being dried. The screens used for the printing were made of 250 & 200-mesh stainless steel wire bonded to a frame. The LSF/YSZ ink was then printed on a 1 cm×1.5 cm print area on both sides of the electrolyte with a 1 cm² area of the print overlapping the print area on the opposite side of the substrate. This print design of the test samples provided an active cathode with an exact area of 1 cm². After printing, the LSF/YSZ composite layers were dried and fired at 1250° C. To reach the firing temperature, temperatures were first slowly ramped to 1250° C., followed by a hold or soak period of 2 hours, after which the fired composition was slowly cooled to ambient conditions. After firing, a current collector was applied to the LSF/YSZ composite. In particular, an Ag/Pd-3YSZ ink was printed on top of the fired LSF/YSZ composite print, dried and subsequently fired at 850° C. for 2 hours. An SEM image of the LSF/3YSZ composite cathode (which is situated on 3YSZ electrolyte) is shown in FIG. 1.

In the following examples, the LSF/8YSZ cathodes evaluated had the stoichiometric formula (La_{0.8}Sr_{0.2})FeO₃+8YSZ. These cathodes were prepared by providing an unsintered mixture comprising 40 weight % of the LSF component and 60 weight % of the 8YSZ component. The same process that was used to prepare inks and print the cathodes for LSF/3YSZ cathodes was also used for preparing the LSF/8YSZ cathodes. The resulting ink composition comprising the unsintered LSF/8YSZ mixture was deposited onto a yttria stabilize zirconia substrate using the screen printing process. The substrate had a thickness of about 20 microns. Once printed and dried, the LSF/8YSZ composite prints were slowly heated to 1150° C., hold at that temperature for 2 hours and then slowly cooled down. The fired LSF/8YSZ composite layer was approximately 4 microns thick.

In the following examples, the so-called LSM/3YSZ reference cathodes of good performance were based on (La_{0.8}Sr_{0.2})_{0.97}MnO₃ and 3YSZ. They were prepared from an unsintered mixture comprising 40 weight % of the LSM component and 60 weight % of the 3YSZ component and contained some NiO/8YSZ. The same process that was used to prepare inks and print the cathodes for LSF/3YSZ cathodes was also used for preparing the LSM/3YSZ cathodes. The LSM/YSZ ink was deposited onto a yttria stabilize zirconia substrate using the screen printing process. The substrate had a thickness of about 20 microns. Once printed and dried, the LSM/3YSZ composite prints were slowly heated to 1250° C., hold at that temperature for 2 hours and then slowly cooled down. The fired LSM/3YSZ composite layer was approximately 4 microns thick.

### Example 1

### Evaluation of Processing Window and Formation of Pyrochlore During Manufacture of Composite LSF/3YSZ Cathode

Considerable pyrochlore formation occurs during high temperature processing or firing of lanthanum strontium ferrite with cubic yttria stabilized zirconia ceramics and even with single crystalline cubic 10 mol % yttria stabilized zirconia. For example, systematic decoration of the 8YSZ grain boundary lines in contact with LSF can occur at temperature of 1000° C. already after 100 hours. At 1250° C., substantial formation of large size plate-shaped grains of pyrochlore is observed in the contact plane of 8YSZ and LSF. However, during processing of the inventive composite LSF/3YSZ composite electrodes, it has been discovered that pyrochlore formation remains negligible after firing at temperatures of up to 1250° C. and for several hours. In fact, only very few isolated pyrochlore particles form, the density and size of which is similar to those found to be formed during the processing of 3YSZ/LSM composite cathodes containing excess Mn.

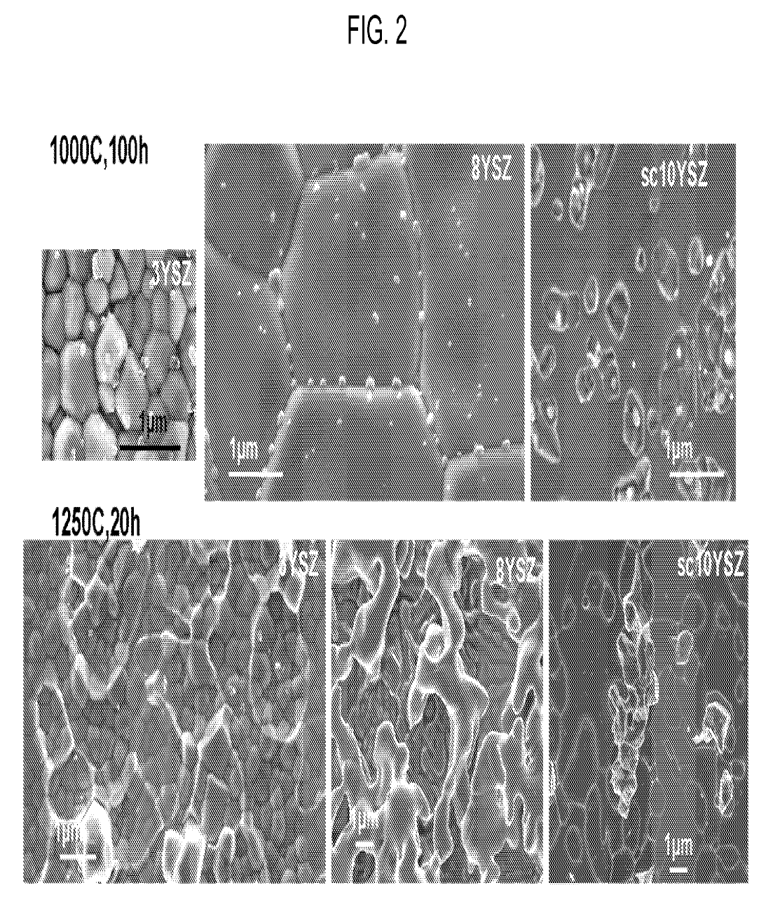

FIG. 2 provides an SEM view of the interfacial plane of reaction couples between an exemplary 3YSZ electrolyte, 8YSZ electrolyte and 10YSZ single crystal and screen-printed (Sr_{0.2}La_{0.8})FeO₃ layer that were annealed in air at 1000° C. for 100 hours (upper part) and at 1250° C. for 25 h (lower part). For evaluation, after reaction the LSF layer was then removed from the diffusion couple by etching with hot acid. The formation of pyrochlore particles at the interface can be easily seen as the bright contrast “islands” present in the SEM images of FIG. 2. Further, it can be deduced that the formation of pyrochlore at LSF/3YSZ contacts in the composite also remains negligible.

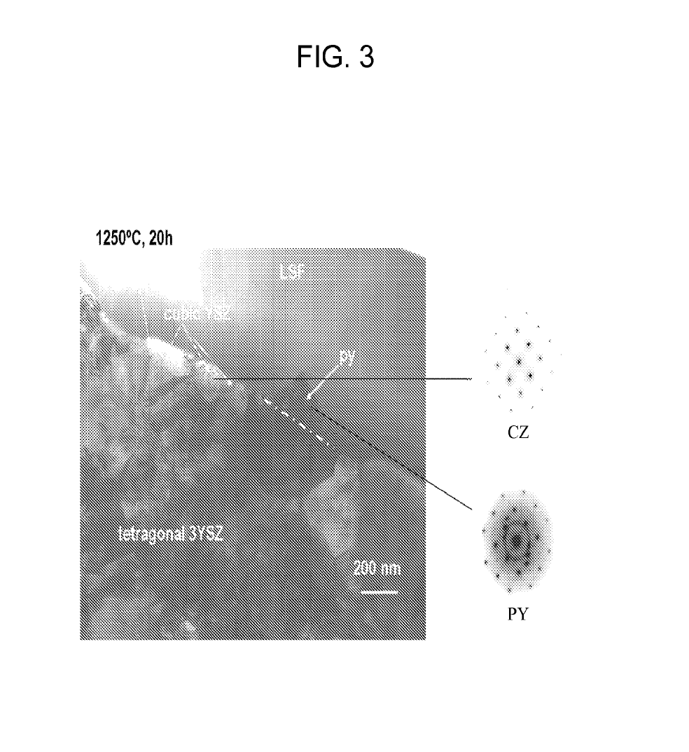

FIG. 3 provides a TEM image of the 3YSZ/LSF interface. (In FIG. 3, CZ stands for cubic zirconia and PY stands for pyrochlore in topotactic orientation.) From this higher magnification image of the diffusion couple, it can be seen that after about 20 hours at 1250° C. no systematic decoration with pyrochlore occurred. Rather, in the initial reaction stages, pyrochlore formation was preceded by the formation of heavily doped, cubic zirconia. FIG. 3 also illustrates that pyrochlore formation occurred only very occasionally along the contact plane of polycrystalline 3YSZ and LSF. Thus, it is believed that the pyrochlore forms only when special crystallographic boundary conditions are present. For example, as shown in the electron diffraction patterns of FIG. 3, the pyrochlore reaction product grows topotaxially on the cubic zirconia, but only if the zirconia orientation in respect to interfacial plane and LSM grain orientation allows easy transformation. Only few special orientation relationships allow easy formation of pyrochlore. As a consequence, very little pyrochlore forms at the reaction couple interfaces and also in randomly mixed LSF/3YSZ ceramic composites.

### Example 2

### Evaluation of Electrochemical Performance of Inventive Composite LSF/3YSZ Cathode

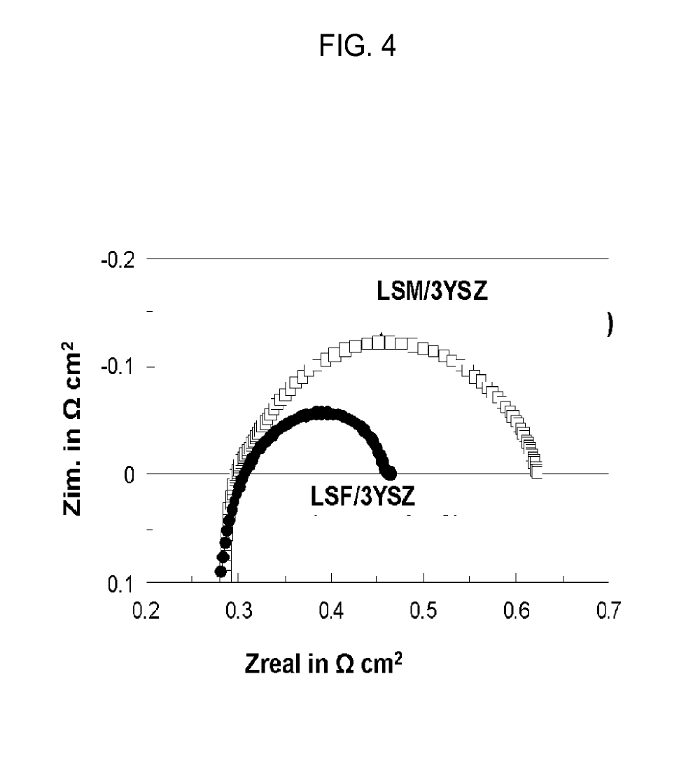

The electrochemical performance of the inventive composite electrodes when sampled in cathode/cathode oxygen pump single cells with 3YSZ electrolyte and Ag—Pd/3YSZ current collectors also shows significant improvements compared to corresponding LSM/3YSZ and LSF/8YSZ cathodes. Comparative data from this evaluation are illustrated in FIG. 4-FIG. 8.

FIG. 4 provides a comparison of impedance spectra of LSF/3YSZ (composite A) and LSM/3YSZ (reference composite) cathode pump samples in air at 750° C. The samples each comprised an electrolyte membrane and two symmetric cathodes with a current collector. The LSF/3YSZ sample was a higher porosity composite cathode (type A). The data show that the LSF/3YSZ cathode resistance is much smaller than that of the corresponding LSM/3YSZ cathode.

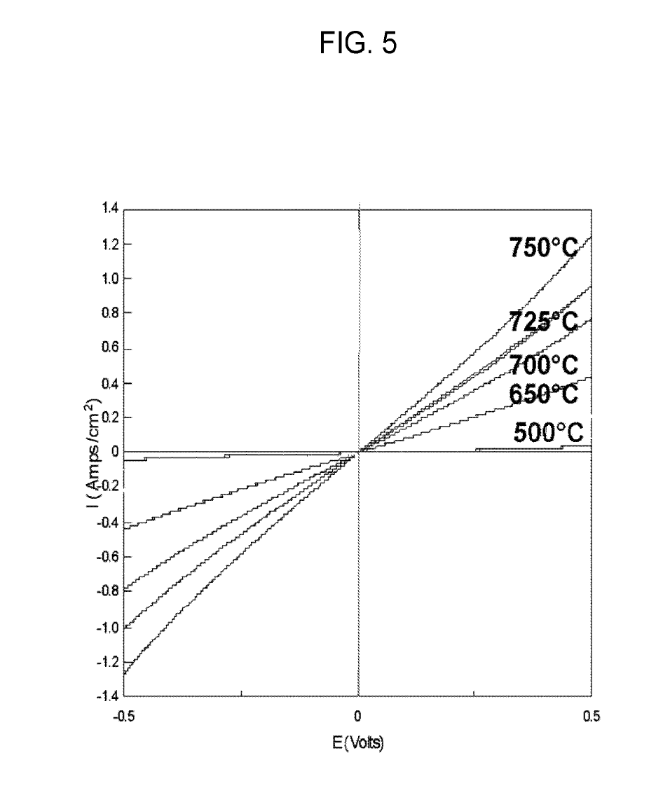

FIG. 5 illustrates the current density and voltage curves (i-V) as a function of temperature for an inventive LSF/3YSZ composite cathode (type A) sampled in ambient air. As shown for example, at a voltage of about 0.5 volts and a temperature of about 750° C., the oxygen pump sample with a thin electrolyte and the exemplary inventive composite cathode exhibits a current density of about 1.3 A/cm².

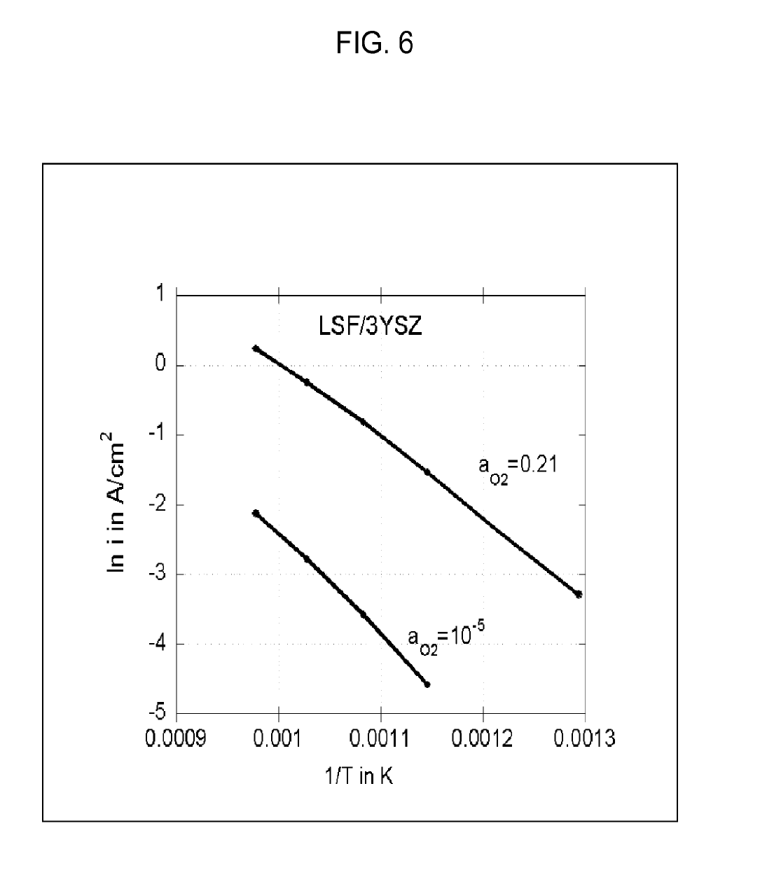

Still further, FIG. 6 illustrates for the same type A (composite A) LSF/3YSZ cathode the temperature dependency in air and at low oxygen partial pressure of the rate determining oxygen incorporation step, illustrating once more the much lower resistance compared to the corresponding LSM/3YSZ cathodes.

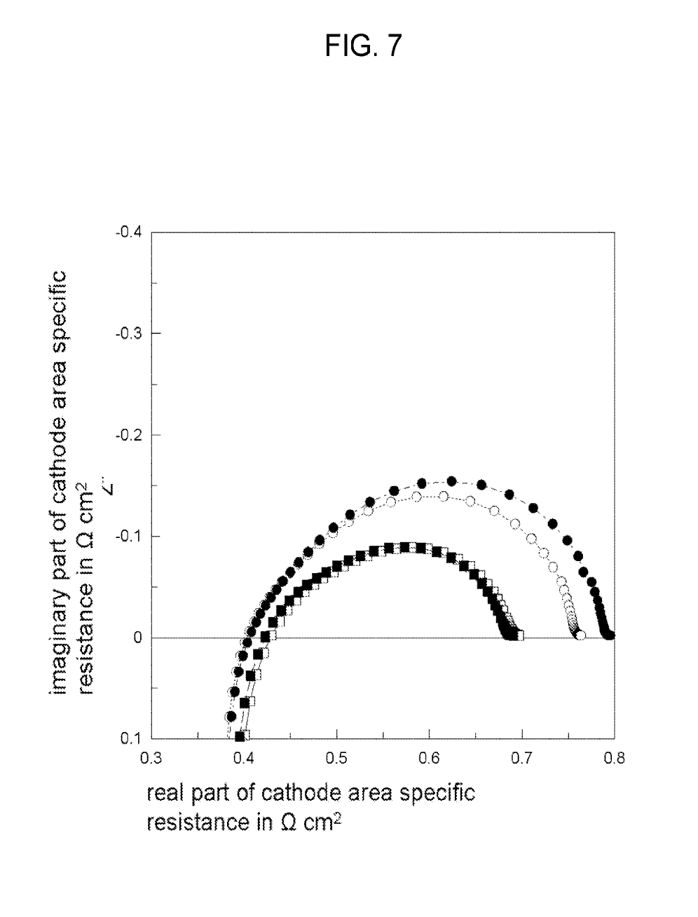

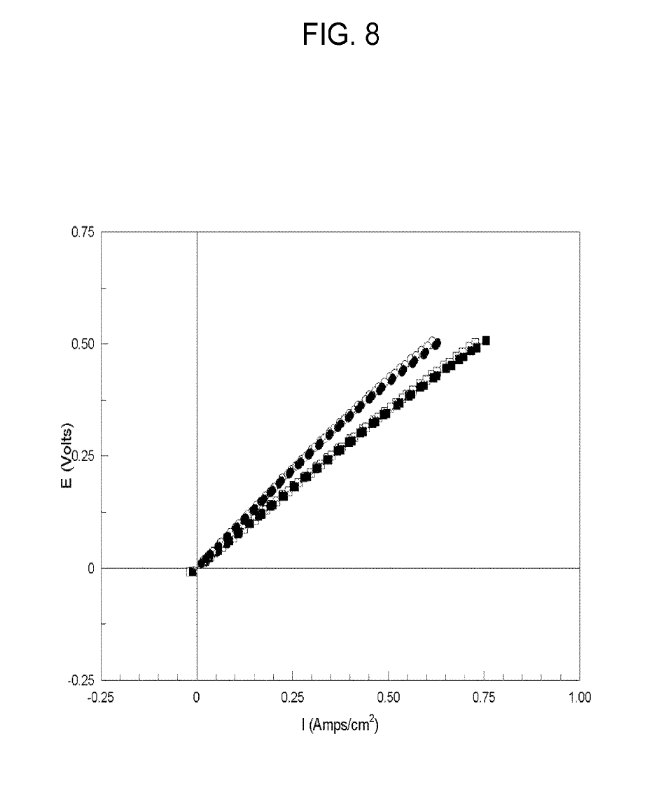

FIG. 7 provides data from a comparison of impedance spectra of cathode pump samples at 725° C. in air for LSF/3YSZ (composite B) (rectangular symbols) and LSF/8YSZ (composite C) (circular symbols) electrodes after 10 hours of operation and again after 1300 hours, illustrating not only the higher cathode resistance of the LSF/8YSZ cathode, but also its higher degradation rate. To that end, the data shows that the initial cathode resistance of the LSF/3YSZ cathode is lower than that of the corresponding LSF/8YSZ cathode and that it remains considerably lower over a significant cathode operation time. In FIG. 7 (and FIG. 8), the light rectangulars corresponds to LSF/3YSZ electrodes after 10 hours of operation and the dark rectangles (filled rectangles) correspond to LSF/3YSZ electrodes after 1300 hours of operation. Similarly, the light circles correspond to LSF/8YSZ electrodes after 10 hours of operation and the dark circles correspond to the LSF/8YSZ electrodes after 1300 hours of operation. The LSF/3YSZ cathode was fired at 1250° C. for 2 hours. The LSF/8YSZ cathode was fired at 1150° C. for 2 hours.

FIG. 8 provides a comparison of the current density—voltage curve data for cathode pump samples of lower porosity composite electrodes LSF/3YSZ (B) and LSF/8YSZ (C) in air at 725° C. Both cathodes were first evaluated during initial operation (after 10 hours of operation) and then again after 1300 hours. The data again illustrates that the inventive LSF/3YSZ composites are capable of providing increased current density levels. In addition, the data also show that degradation over time is even lower for the LSF/3YSZ cathodes than for LSF/8YSZ cathodes.

### Example 3

### Evaluation of Performance Degradation of LSF/3YSZ Cathodes in Presence of Borosilicate Glasses

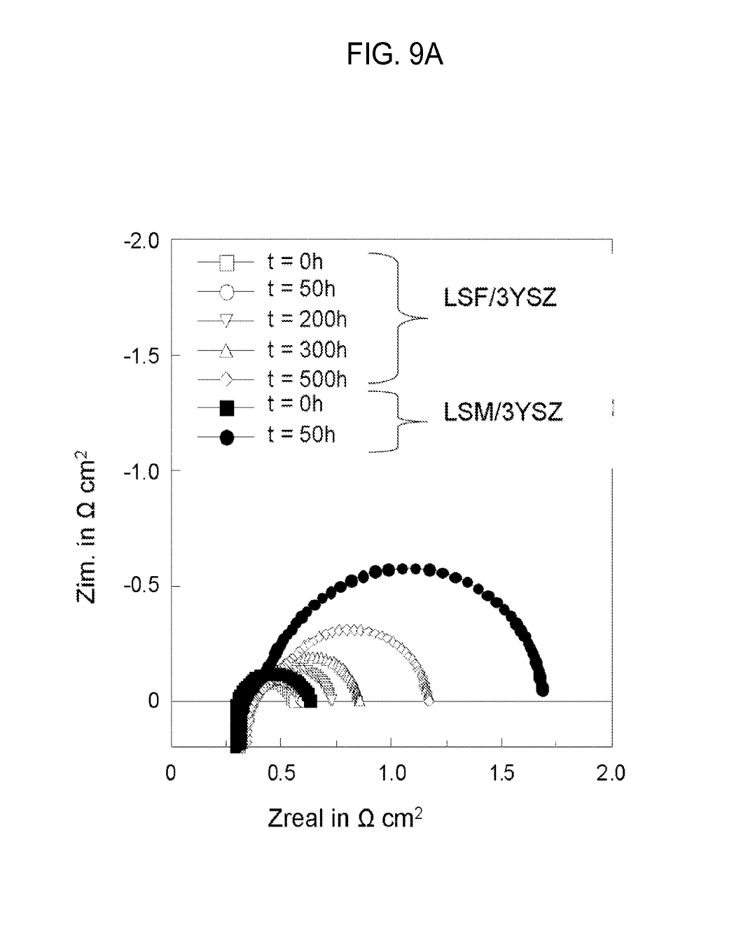

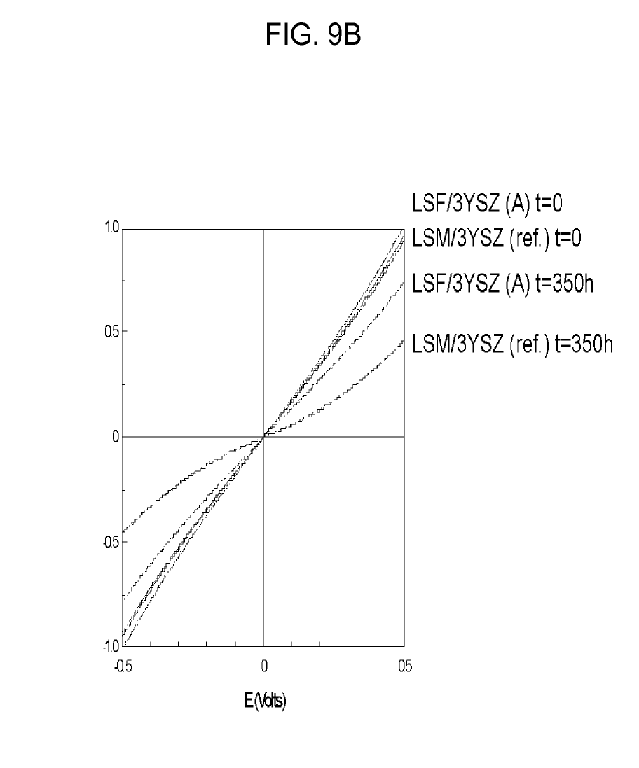

With reference to FIGS. 9-11, it can be seen that in the presence of borosilicate glass, the inventive LSF/3YSZ cathodes can exhibit slower degradation rates and preserve higher cathode performance levels than do the corresponding LSM/3YSZ composite cathodes. For example, FIGS. 9A and 9B illustrate the cathode performance in presence of an alkali-containing borosilicate seal glass at 750° C. in air for a reference LSM/3YSZ cathode (ref) and a type LSF/3YSZ cathode (A). FIG. 9A shows initial cathode impedance and impedance after various operation times. The impedance data show that after only 50 hours the LSM/3YSZ (ref) cathode has already suffered much larger degradation than the LSF/3YSZ (type A) cathode exhibited after more than 500 hours. The same effect is also demonstrated by the evolution of the current density of the cathodes over time. FIG. 9B shows that the inventive LSF/3YSZ cathodes preserve much higher current densities (A/cm²) than the reference LSM/3YSZ cathodes over similar time periods. More specifically, FIG. 9B illustrates relative performance of cathode pump sample exposed to glass for time t normalized to initial clean cathode pump sample performance at 0.5 volts (and 750° C.) i(t)/i(t=0, u=0.5V) versus E(volts).

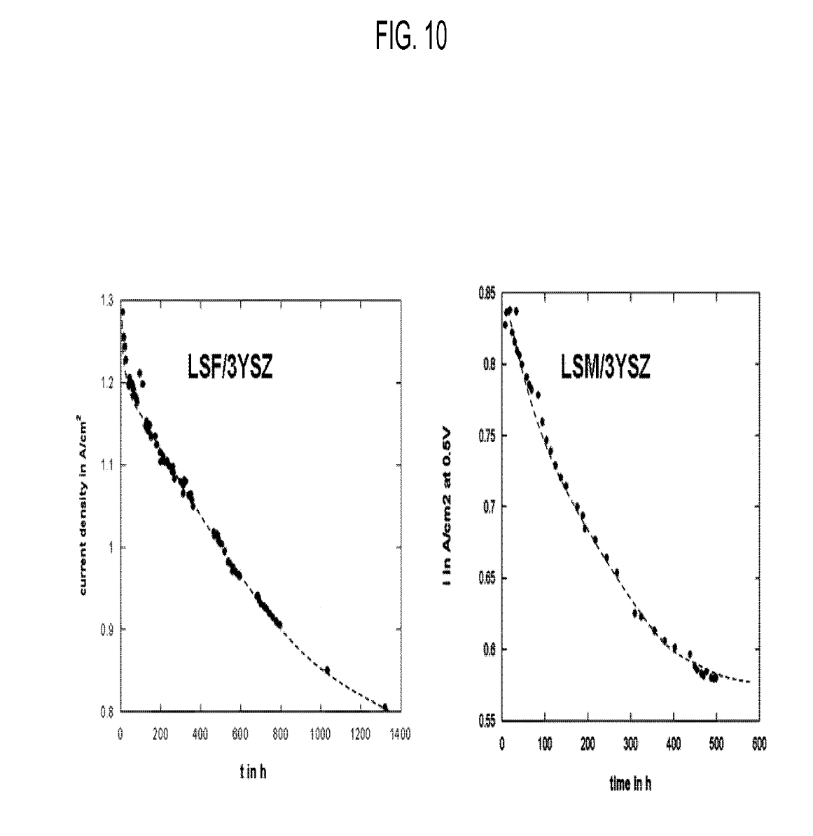

FIG. 10 similarly illustrates the cathode performance in presence of an alkali-free borosilicate seal glass at 750° C. in air for LSM/3YSZ (reference composite) and LSF/3YSZ (type A composite) cathodes in air over extended periods of time. In the presence of that borosilicate glass, very low degradation rates can be observed for the inventive cathodes. In particular, after more than 1000 hours of exposure, current densities can still remain at or near the starting performance of comparative LSM/3YSZ cathodes. Further, in the presence of the glass, the oxygen pump samples with thin 3YSZ electrolyte and LSF/3YSZ cathodes still preserve a current density of 0.8 A/cm² after more than 1300 hours, while the initial value for LSM/3YSZ cathodes was close to this value and the current density after 600 hours had dropped to 0.5 A/cm².

### Example 4

### Evaluation of Performance Degradation of LSF/3YSZ Cathodes During Cathode Operation in Presence of Chromium

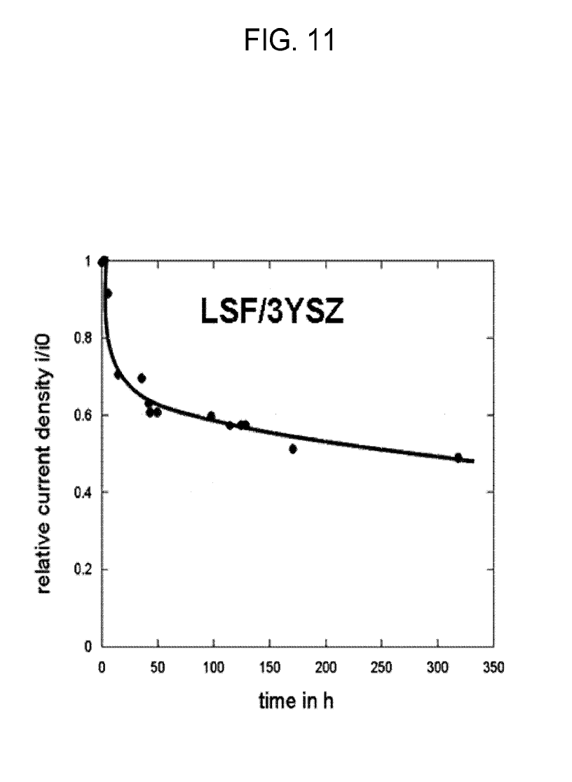

During cathode operation, LSF/3YSZ cathodes can suffer under polarization and in presence of a chromium source the well-known Cr-poisoning from CrO₃ or CrO₂(OH)₂ vapor that is electrochemically reduced at the cathode surface and forms chromium oxide Cr₂O₃ and spinel precipitates at the surface that inhibit the further oxygen incorporation into the cathode. To that end, FIG. 11 illustrates exemplary relative current density with time for oxygen pump samples with thin electrolyte and LSF/3YSZ cathode (type A composite) in presence of chromium oxide at 750° C., humid air flow under bias −0.3V. The current density shown is normalized to the initial current density of the cathode prior to exposure of Cr₂O₃. The initial performance is characterized by a current density of 1.35 A/cm² and after 300 hours still shows 0.7 A/cm². It should also be noted that the CrO3 vapor pressure for the present data was obtained under humid air flow with air being saturated at room temperature with water vapor. Corresponding LSM/3YSZ reference cathodes show under these harsh conditions with very high chromium trioxide and chromium hydroxyoxide vapor pressure a rapid drop of their performance under such conditions from 0.8 A/cm² to 0.2 A/cm² in 300 hours of operation as biased cathode pump sample.

Lastly, it should also be understood that while the present invention has been described in detail with respect to certain illustrative and specific embodiments thereof, it should not be considered limited to such, as numerous modifications are possible without departing from the broad scope of the present invention as defined in the appended claims.

1. A porous oxygen conducting composite electrode, comprising a sintered mixture of lanthanum strontium ferrite component having the formula (LaₓSr_{y})_{1±δ}(FeₐMn_{b}Co_{c})O₃ and a stabilized zirconia; wherein 1.0≧x≧0.65; 0.35≧y≧0.0; x+y=1.0, δ=0-0.1, a+b+c=1 and a>0.6.

2. The oxygen conducting composite electrode of claim 1, wherein the sintered mixture comprises from 30 weight % to about 90 weight % of the lanthanum strontium ferrite component and from 70 weight % to 10 weight % of the stabilized zirconia.

3. The oxygen conducting composite electrode of claim 1, wherein the sintered mixture comprises from 30 weight % to about 50 weight % of the lanthanum strontium ferrite component and from 70 weight % to 50 weight % of the stabilized zirconia.

4. The oxygen conducting composite electrode of claim 2, wherein the sintered mixture comprises about 40 weight % of the lanthanum strontium ferrite component and about 60 weight % of the stabilized zirconia.

5. The oxygen conducting composite electrode of claim 1, wherein the lanthanum strontium ferrite component is characterized by the formula (La_{0.8}Sr_{0.2})_{1-δ}FeO₃, and wherein δ is 0-0.1.

6. The oxygen conducting composite electrode of claim 1, wherein the zirconia is stabilized by yttria.

7. The oxygen conducting composite electrode of claim 6, wherein the yttria stabilized zirconia is a 3 mol % yttria stabilized zirconia.

8. The oxygen conducting composite electrode of claim 1, wherein the electrode exhibits an initial cathode area specific resistance less than approximately 0.07 ohm cm² when measured at 0.5V in air at 750° C.

9. The oxygen conducting composite electrode of claim 1, wherein the electrode is in direct contact with an electrolyte membrane.

10. The oxygen conducting composite electrode of claim 9, wherein the electrolyte membrane comprises yttria stabilized zirconia.

11. The oxygen conducting composite electrode of claim 10, wherein the electrolyte membrane comprises 3YSZ.

12. The oxygen conducting composite electrode of claim 11, wherein the electrolyte membrane has a thickness less than or equal to 50 μm.

13. The oxygen conducting composite electrode of claim 12, wherein the electrode exhibits a current density of at least 1.0 A/cm² when measured in a cathode pump operated at 0.5 volts and 750° C.

14. The oxygen conducting composite electrode of claim 13, wherein the composite electrode exhibits a current density of at least 1.3 A/cm² at 0.5 volts and 750° C.

15. A solid oxide fuel cell device comprising the oxygen conducting composite electrode of claim 1.

16. A method for making a solid oxide fuel cell electrode, comprising:
providing an unsintered composition comprising a mixture of a lanthanum strontium ferrite component having the formula (LaₓSr_{y})_{1±δ}(FeₐMn_{b}Co_{c})O₃ and a yttria stabilized zirconia component, wherein 1.0≧x≧0.65; 0.35≧y≧0.0; x+y=1.0, δ=0-0.1, a+b+c=1, and a>0.6;
depositing the composition onto a substrate; and
sintering the deposited composition under conditions effective to convert the deposited composition into a sintered porous composite structure suitable for use as a solid oxide fuel cell electrode.

17. The method of claim 16, wherein the unsintered composition comprises from 30 weight % to about 90 weight % of the lanthanum strontium ferrite and from 70 weight % to 10 weight % of the yttria stabilized zirconia.

18. The method of claim 16, wherein the unsintered composition comprises from 30 weight % to about 50 weight % of the lanthanum strontium ferrite and from 70 weight % to 50 weight % of the yttria stabilized zirconia.

19. The method of claim 16, wherein the unsintered composition comprises about 40 weight % of the lanthanum strontium ferrite and about 60 weight % of the yttria stabilized zirconia.

20. The method of claim 16, wherein the lanthanum strontium ferrite component is characterized by the formula (La_{0.8}Sr_{0.2})_{1-δ}FeO₃.

21. The method of claim 16, wherein the yttria stabilized zirconia is a 3 mol % yttria stabilized zirconia.

22. The method of claim 16, wherein the substrate is an electrolyte membrane.

23. The method of claim 22, wherein the electrolyte membrane comprises yttria stabilized zirconia.

24. The method of claim 16, wherein the sintering conditions comprise heating the deposited mixture at a temperature in the range of from 1000° C. to 1250° C. for a period of time sufficient to form the sintered porous composite structure.

25. The method in claim 16 where the unsintered composition is provided as an ink composition and wherein the mixture of a lanthanum strontium ferrite component and the yttria stabilized zirconia component is present in the ink composition at a solids loading in the range of from 10 to 30 volume percent.
